(19) United States
(12) Patent Application Publication
(10) Pub. No.: US 2013/0182354 A1
(43) Pub. Date: Jul. 18, 2013

(54) OVERVOLTAGE PROTECTION DURING GCU FAILURE

(71) Applicants: Vijay K Maddali, Rockford, IL (US); Carl A. Wagner, Beloit, WI (US)

(72) Inventors: Vijay K Maddali, Rockford, IL (US); Carl A. Wagner, Beloit, WI (US)

(73) Assignee: HAMILTON SUNDSTRAND CORPORATION, Windsor Locks, CT (US)

(21) Appl. No.: 13/352,768

(22) Filed: Jan. 18, 2012

(51) Int. Cl. H02H 7/06

(52) U.S. Cl. 361/21

(57) ABSTRACT

An overvoltage protection system for a power generating system includes a generator control relay (GCR) controlling a conduction path through a generator exciter field, a flyback impedance in parallel communication with the generator exciter field, the flyback impedance configured to dissipate energy from the generator exciter field in response to opening of the conduction path, a gate drive configured to open and close the GCR, and an overvoltage prevention unit in signal communication with the gate drive, the overvoltage prevention unit configured to monitor a voltage and a current associated with the generator and selectively open and close the conduction path in response to the monitored voltage and current.

### BACKGROUND OF THE INVENTION

The present invention generally relates to generator control units (GCU), and more particularly, exemplary embodiments of the present invention relate to overvoltage protection during GCU failures.

Conventionally, an aircraft power generating system is controlled by a GCU such that generator output voltage is regulated during normal operations. The GCU may also limit a generator's output current to be within specified limits during fault conditions, such as short circuits at output terminals. In variable frequency generating systems, there may be a potential for significant overvoltage if an associated generator is over-excited due to GCU failure, or multiple smaller failures within a GCU.

### BRIEF DESCRIPTION OF THE INVENTION

According to an exemplary embodiment of the present invention, an overvoltage protection system for a generator of a power generating system includes a generator control relay (GCR) controlling a conduction path through a generator exciter field, a flyback impedance in parallel communication with the generator exciter field, the flyback impedance configured to dissipate energy from the generator exciter field in response to opening of the conduction path, a gate drive configured to open and close the GCR, and an overvoltage prevention unit in signal communication with the gate drive, the overvoltage prevention unit configured to monitor a voltage and a current associated with the generator and selectively open and close the conduction path in response to the monitored voltage and current.

According to another exemplary embodiment of the present invention, a method of overvoltage protection of a generator of a power generating system includes determining if line current of the generator is at or above a design threshold, and modulating a conduction path of an exciter field of the generator between open and closed to reduce the line current in response to the determining

### BRIEF DESCRIPTION OF THE DRAWINGS

The subject matter which is regarded as the invention is particularly pointed out and distinctly claimed in the claims at the conclusion of the specification. The foregoing and other features, and advantages of the invention are apparent from the following detailed description taken in conjunction with the accompanying drawings in which:

FIG. 1 is a schematic of an overvoltage protection system for a power generating system according to an exemplary embodiment of the present invention;

FIG. 2 is a flowchart of a method of overvoltage protection for a power generating system according to an exemplary embodiment of the present invention; and

FIG. 3 is a flowchart of an alternative method of overvoltage protection for a power generating system according to an exemplary embodiment of the present invention.

### DETAILED DESCRIPTION OF THE INVENTION

According to exemplary embodiments of the present invention, an overvoltage protection system is provided which reduces the risk of overvoltage in power generating systems, even in the event of a generator control unit (GCU) failure. The technical effects and benefits of exemplary embodiments of the present invention include broader protection for power generating systems under a variety of conditions.

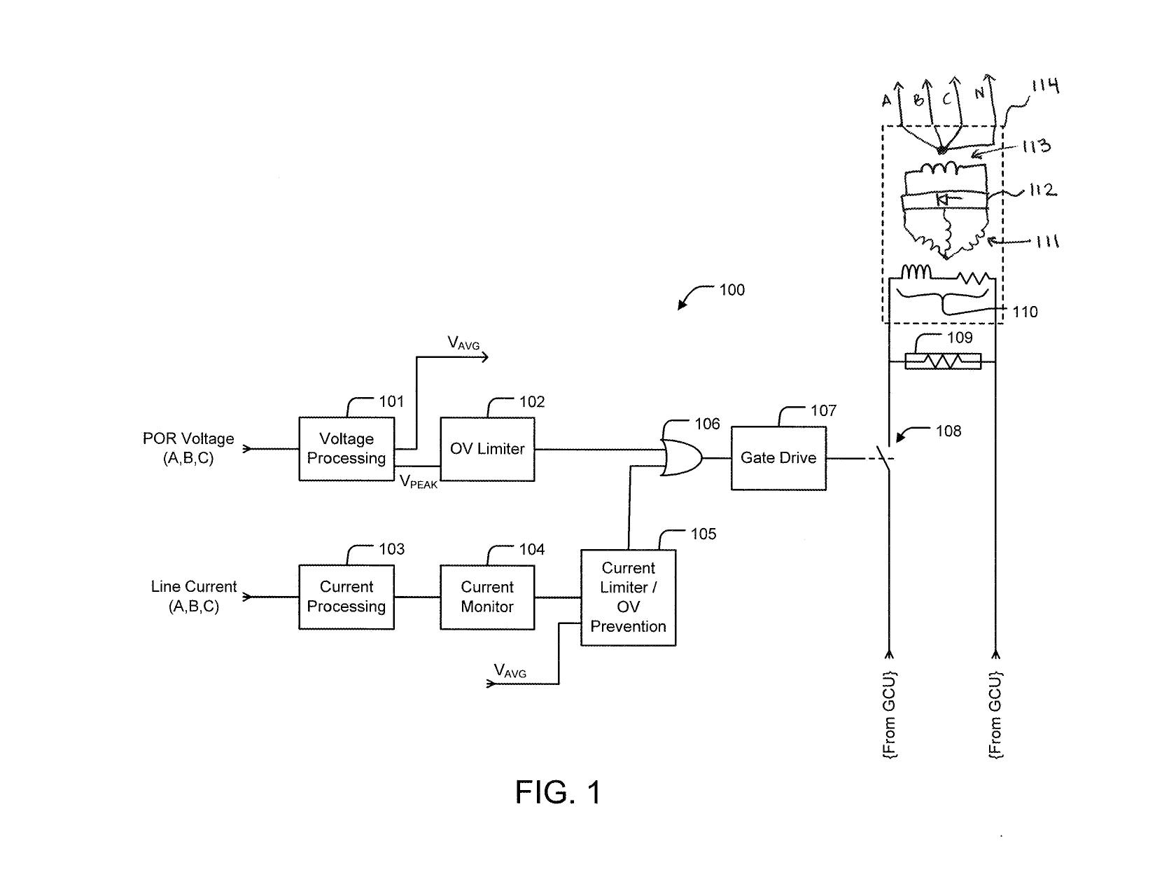

Turning to FIG. 1, a schematic of an overvoltage protection system 100 for a GCU is illustrated. As shown, the system 100 includes voltage processing unit 101. The voltage processing unit 101 is configured to sense point of regulation (POR) voltage(s) for a generator 114. The generator 114 may include exciter 111 with an associated exciter field 110, bridge rectifier 112 in communication with the exciter, and main field 113 in communication with the bridge rectifier 112. The sensed POR voltages from the generator may be three-phase (A,B,C) voltages. The voltage processing unit 101 is further configured to determine an average value of the POR voltage, V_{AVG}, and output the same to current limiter 105. The voltage processing unit 101 is further configured to determine a maximum peak voltage, Vpeak, and output the same to overvoltage limiter 102. The overvoltage limiter 102 may be a limiting device configured to activate an overvoltage signal, fault, or flag in the event Vpk exceeds valid design or desired thresholds.

The system 100 further includes current processing unit 103. The current processing unit 103 is configured to sense line current(s) for 114 the main generator. Thus, the current processing unit 103 may be in current sensing communication with the generator 114, such that actual line current(s) of the main generator 114 may be sensed. The line current(s) may be a three phase (A,B,C) current(s), depending upon any desired implementation. The current processing unit 103 is further configured to determine a peak value of the line current, and output the same to the current monitor 104. The current monitor 104 is configured to monitor the peak value output from current processing unit 103, and compare the same to a desired range of applicable current, for example, as compared to a target current curve profile for appropriate operation of the generator and/or power generating system. The output of the comparison is provided to current limiter/overvoltage prevention unit 105. The current limiter/overvoltage prevention unit 105 is configured to process the current information received from the current monitor 104 and the average voltage V_{AVG} to determine if an overcurrent condition exists, and is further configured to activate an overcurrent signal, fault, or flag if the monitored current exceeds valid design or desired thresholds.

As illustrated, the current limiter/overvoltage prevention unit 105 provides the fault information to logic unit 106. Furthermore, logic unit 106 receives overvoltage fault information from overvoltage limiter 102. The logic unit 106 outputs a positive (e.g., logical 1) control signal whenever either or both of an overvoltage or an overcurrent fault exists to gate drive 107. Gate drive 107 is configured to drive (e.g., open/close) generator control relay (GCR) 108 depending upon the control signals received from logic unit 106. The GCR 108 is configured to sever a conduction path between the GCU and the exciter field 110 of the generator. Thus, if fault information processed at logic unit 106 is indicative of a fault, the gate drive 107 may open or modulate the GCR 108 to drive down exciter field current or sever the connection entirely. Whenever the conduction path is severed, a shunt flyback impedance 109 is provided to allow power within the exciter field 110 to dissipate relatively quickly. The flyback impedance 109 may include a set of transient voltage suppressors (transorbs) and/or a relatively high resistance in series with a control switch.

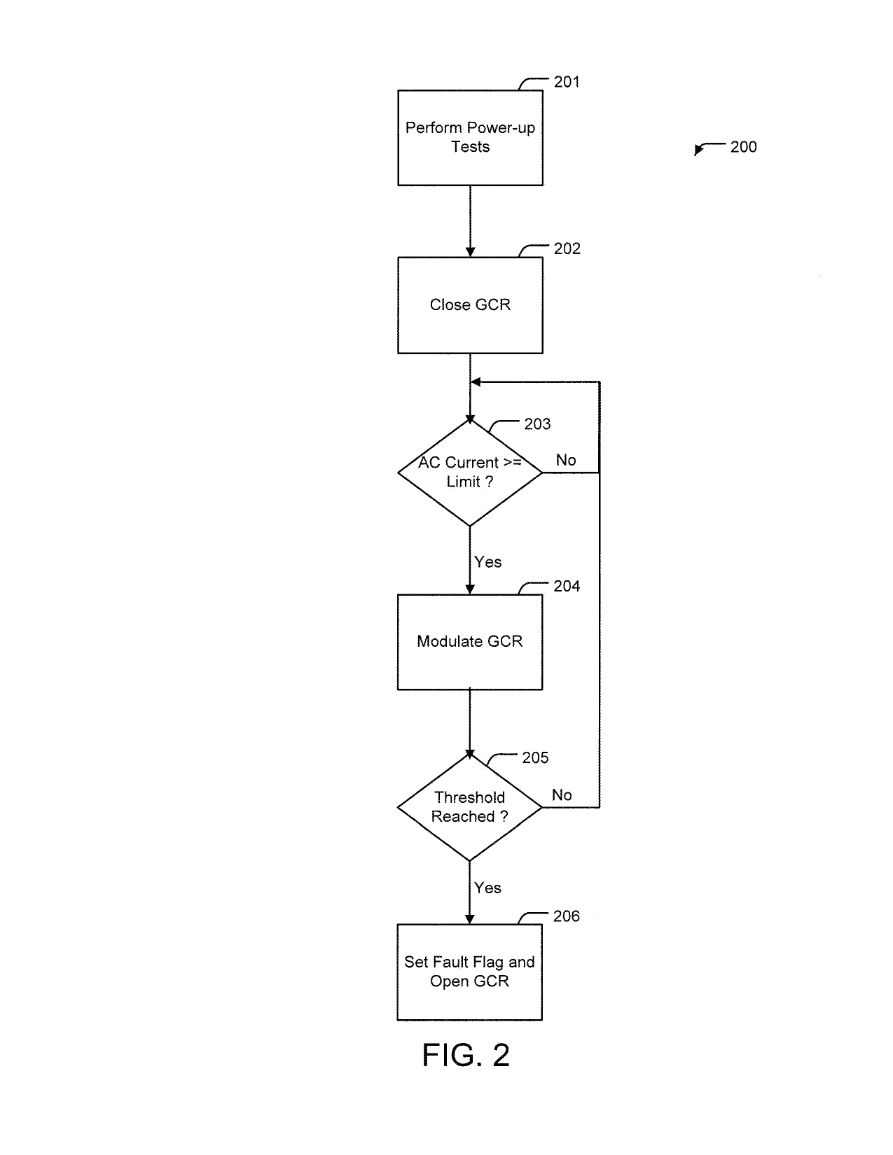

Therefore, as described above, a topology for a protective system is provided which operates in unison with a GCU to limit and mitigate the risk of overvoltage even in the event of GCU failure. Hereinafter, a methodology describing the logical execution of the current limiter/overvoltage prevention unit 105 is described with reference to FIG. 2.

Turning to FIG. 2, a method of overvoltage protection for a GCU is provided. As shown, the method 200 includes performing power-up tests of protection circuitry at block 201. The power-up tests may include injecting a sequence of phase-shifted test signals of varying amplitudes at respective POR voltage and line current inputs of voltage processing and current processing units 101 and 103. The test signals may be used to simulate a fault, short circuit, or other scenario. After testing, the method 200 includes closing a GCR at block 202. For example, closing the GCR may include supplying a control signal to gate drive 107 indicative of a system power-up or by issuing a GCR close request to the gate drive 107.

Thereafter, the method 200 includes determining if actual line current of main generator 114 is at or above a design threshold at block 203. If line current is normal or within operating specifications, for example as determined through comparison with a target current curve, the GCR may remain closed and current may be continually monitored at block 203. Alternatively, if the actual line current of the main generator 114 is at or above design thresholds, the method 200 may include modulating the GCR 108 to limit the actual line current.

For example, modulating the GCR may include providing a pulse-width modulated (PWM) control signal to gate drive 107 which provides for the opening and closing of the GCR 108 at predetermined intervals. The PWM control signal may have any desirable duty cycle configured to limit the actual line current of the main generator 114. During modulation, the method 200 includes determining if an overall threshold has been reached at block 205.

According to at least one exemplary embodiment, an overall threshold may be a configurable time period at which a main generator may operate at elevated current or elevated voltage. Thus, if the configurable time period has lapsed, a fault flag may be set and the GCR may be opened and stay opened such that the electrical connection to the excited field 110 is severed at block 206. The time period may be measured through hardware or software based counters enabled within the current limiter/OV prevention unit 105. Alternatively, a clocking system may be integrated to measure time expired during overcurrent conditions.

Turning back to FIG. 2, if the overall threshold has not been reached, monitoring may be continued at block 203 until either a current limit is within design specifications or a fault is thrown at block 206.

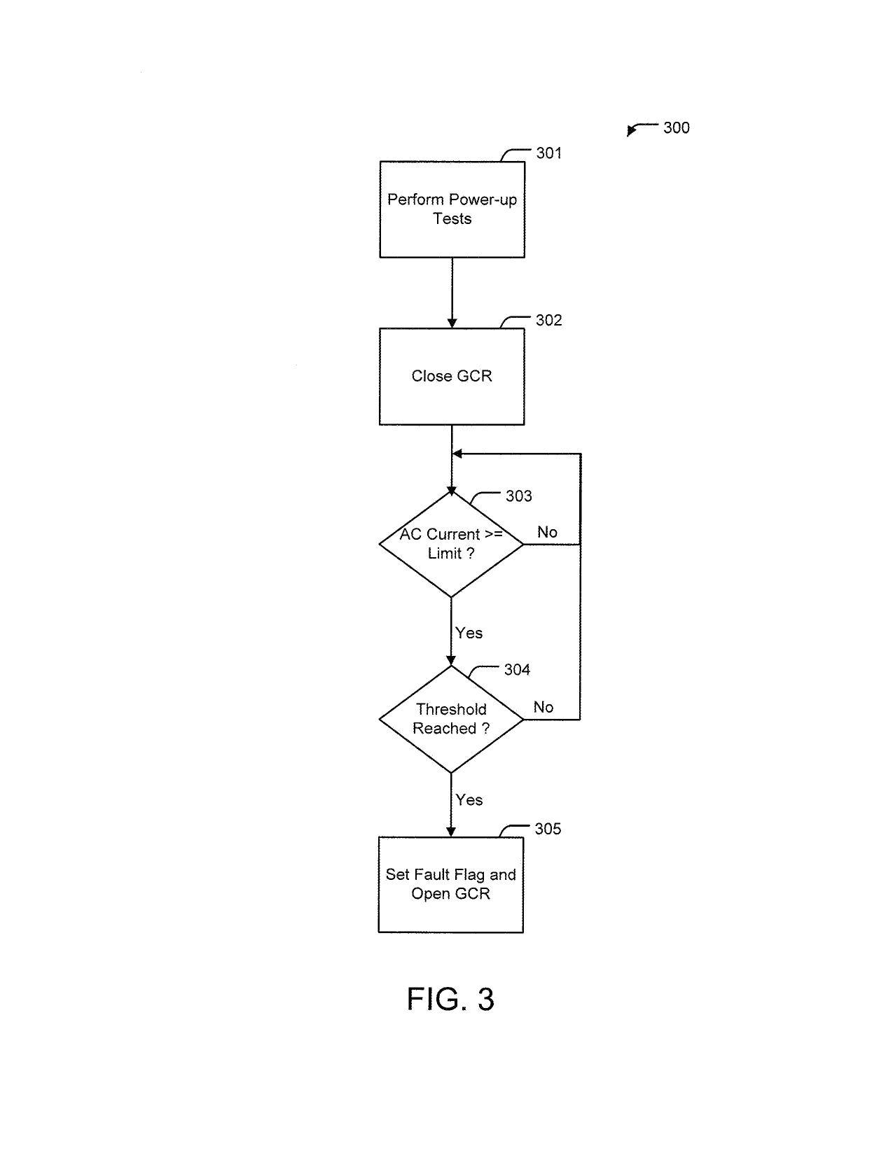

Turning now to FIG. 3, an alternative method of overvoltage protection for a GCU is provided. As shown, the method 300 is somewhat similar to the method 200, however lacking GCR modulation as described below.

The method 300 includes performing power-up tests of protection circuitry at block 301. The power-up tests may include injecting a sequence of phase-shifted test signals of varying amplitudes at respective POR voltage and line current inputs of voltage processing and current processing units 101 and 103. The test signals may be used to simulate a fault, short circuit, or other scenario. After testing, the method 300 includes closing a GCR at block 302. For example, closing the GCR may include supplying a control signal to gate drive 107 indicative of a system power-up or by issuing a GCR close request to the gate drive 107.

Thereafter, the method 300 includes determining if actual line current of main generator 114 is at or above a design threshold at block 303. If line current is normal or within operating specifications, for example as determined through comparison with a target current curve, the GCR may remain closed and current may be continually monitored at block 303. Alternatively, if the actual line current of the main generator 114 is at or above design thresholds, the method 300 may include determining if an overall threshold has been reached at block 304.

According to at least one exemplary embodiment, an overall threshold may be a configurable time period at which a main generator may operate at elevated current or elevated voltage. Thus, if the configurable time period has lapsed, a fault flag may be set and the GCR may be opened and stay opened such that the electrical connection to the excited field 110 is severed at block 305. The time period may be measured through hardware or software based counters enabled within the current limiter/OV prevention unit 105. Alternatively, a clocking system may be integrated to measure time expired during overcurrent conditions.

Turning back to FIG. 3, if the overall threshold has not been reached, monitoring may be continued at block 303 until either a current limit is within design specifications or a fault is thrown at block 305.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. An overvoltage protection system for a generator of a power generating system, comprising:
a generator control relay (GCR) controlling a conduction path through a generator exciter field;
a flyback impedance in parallel communication with the generator exciter field, the flyback impedance configured to dissipate energy from the generator exciter field in response to opening of the conduction path;
a gate drive configured to open and close the GCR; and
an overvoltage prevention unit in signal communication with the gate drive, the overvoltage prevention unit configured to monitor a voltage and a current associated with the generator and selectively open and close the conduction path in response to the monitored voltage and current.

2. The system of claim 1, further comprising a current monitor in signal communication with the overvoltage prevention unit, the current monitor configured to compare a sensed phase voltage of the generator with a predetermined current limit curve and provide an output of the comparison to the overvoltage prevention unit.

3. The system of claim 2, further comprising a current processing unit in current sensing communication with the generator and in signal communication with the current monitor, the current processing unit configured to sense and process the line current of the generator.

4. The system of claim 3, further comprising a voltage processing unit in voltage sensing communication with the generator and in signal communication with the overvoltage prevention unit, the voltage processing unit configured to sense and average a point of regulation voltage of the generator.

5. The system of claim 4, further comprising an overvoltage limiter unit in signal communication with the voltage processing unit and the gate drive, the overvoltage limiter unit configured to signal a fault condition if a peak voltage provided by the voltage processing unit is above a predetermined value.

6. The system of claim 5, wherein the overvoltage prevention unit is configured to perform a method of overvoltage protection, the method comprising:
determining if line current of the generator is at or above a design threshold; and
modulating the GCR between open and closed states to reduce the line current in response to the determining.

7. The system of claim 6, wherein modulating the GCR comprises:
providing a pulse-width modulated (PWM) control signal to the gate drive.

8. The system of claim 7, wherein the PWM control signal includes a duty cycle configured to limit the line current of the generator.

9. The system of claim 8, wherein the method further comprises:
determining if an overall protection threshold has been reached in response to the modulating; and
if the overall protection threshold has been reached, opening the GCR to sever the conduction path of the exciter field.

10. The system of claim 9, wherein the overall protection threshold includes a configurable time period of operation of the generator at elevated current levels.

11. A method of overvoltage protection of a generator of a power generating system, comprising:
determining if line current of the generator is at or above a design threshold for a generator of the power generating system; and
modulating a conduction path of the exciter field between open and closed to reduce the line current in response to the determining.

12. The method of claim 11, wherein modulating the conduction path comprises:
modulating a generator control relay (GCR) between open and closed states.

13. The method of claim 12, wherein modulating the GCR comprises:
generating a pulse-width modulated (PWM) control signal to drive the GCR.

14. The method of claim 13, wherein the PWM control signal includes a duty cycle configured to limit the line current of the generator.

15. The method of claim 14, further comprising:
determining if an overall protection threshold has been reached in response to the modulating; and
if the overall protection threshold has been reached, opening the GCR to sever the conduction path of the exciter field.

16. The method of claim 15, wherein the overall protection threshold includes a configurable time period of operation of the generator at elevated current levels.
